(19) United States
(12) Patent Application Publication
(10) Pub. No.: US 2010/0211260 A1
(43) Pub. Date: Aug. 19, 2010

(54) SYSTEM AND METHOD FOR DETECTING THE POLLUTING EMISSIONS OF ROAD VEHICLES OR THE LIKE

(76) Inventor: Davide De Sanctis, Villanova di Guidonia (IT)

Correspondence Address: COLLARD & ROE, P.C., 1077 NORTHERN BOULEVARD, ROSLYN, NY, 11576, US

(21) Appl. No.: 12/733,653

(22) PCT Filed: Mar. 3, 2008
(86) PCT No.: PCT/IB2008/000474

§ 371 Date: Apr. 1, 2010

(30) Foreign Application Priority Data
Oct. 5, 2007 (IT) MO2007A000304

(51) Int. Cl. G07C 5/08; G06F 7/00; G01S 19/42

(52) U.S. Cl. 701/33; 342/357.25

(57) ABSTRACT

System for detecting the polluting emissions of road vehicles or the like, comprising an electronic appliance installable on at least one vehicle and suitable for collecting data relating to the use of the vehicle, and at least one remote unit suitable for determining the polluting emissions of the vehicle, during a predefined time or spatial interval and starting with the collected data. Method for detecting the polluting emissions of road vehicles or the like, comprising collecting data relating to the use of at least one vehicle, and determining the polluting emissions of the vehicle, during a predefined time or spatial interval and starting with the collected data.

### TECHNICAL FIELD

This invention relates to a system and a method for detecting the polluting emissions of road vehicles or the like.

### BACKGROUND ART

The fast increasing number of environmental policies is known aimed at limiting atmospheric pollution.

With special reference to the European directives relating to pollutants produced by vehicles, classifying road vehicles into different categories is currently known, defined on the basis of standard characteristics of emission of pollutants such as nitrogen oxides, carbon monoxide, etc.

Different taxations are then applied according to the category to which the vehicle belongs: in particular, higher taxations are envisaged for vehicles with higher emission of pollutants, so as to prompt their replacement with latest-generation and less-polluting vehicles.

The assessment of the environmental emissions according to the type of vehicles does not however permit determining the actual environmental impact of each single vehicle.

Such environmental impact does in fact depend not only on the emissions declared by the vehicle manufacturer, but also on how much the vehicle is used in terms of distances covered, actual period of use and how it is driven.

This therefore does not allow developing environmental strategies, such as taxation plans, incentive plans and environmental policies within specific areas, which are fair and directly related to the actual polluting emissions of each single vehicle.

### OBJECT OF THE INVENTION

The main aim of this invention is to find a system and a method for detecting the polluting emissions of road vehicles or the like, that allows assessing the actual environmental impact of a vehicle.

Another object of this invention is to allow the development of environmental strategies, such as taxation plans, incentive plans and environmental policies within specific areas, which are related to the actual polluting emissions of the vehicle.

Another object of the invention is to allow measuring the polluting emissions of a group of vehicles transiting inside a predetermined area, in order to separate actual vehicle pollution from overall pollution, which can be detected by means of conventional ground units positioned inside such area.

Another object of this invention is to find a system and a method for detecting the polluting emissions of road vehicles or the like that allows overcoming the above drawbacks of the state of the art as part of a simple and rational solution that is easy and effective to use, as well as inexpensive.

The above objects are all achieved by this system for detecting the polluting emissions of road vehicles or the like, characterised by the fact that it comprises at least one electronic appliance installable on a vehicle and suitable for collecting data relating to the use of the vehicle, and at least one remote unit suitable for determining the polluting emissions of said vehicle, during at least a predefined time or spatial interval and starting with said collected data.

The above objects are all furthermore achieved by this method for detecting the polluting emissions of road vehicles or the like, characterised by the fact that it comprises collecting data relating to the use of at least one vehicle, and determining the polluting emissions of said vehicle, during at least a predefined time or spatial interval and starting with said collected data.

### BRIEF DESCRIPTION OF THE DRAWINGS

Further characteristics and advantages of this invention will appear more evident from the description of a preferred, but not only, embodiment of a system and a method for detecting the polluting emissions of road vehicles or the like, illustrated indicatively by way of non limiting example, in the attached drawings wherein:

FIG. 1 is a general diagram showing the system according to the invention;

FIG. 2 is a general diagram showing the electronic appliance of the system according to the invention;

FIG. 3 is a general diagram showing the remote unit according to the invention;

FIG. 4 is a general functional diagram showing the method according to the invention.

### EMBODIMENTS OF THE INVENTION

With special reference to such figures, by 1 has been globally indicated a system for detecting the polluting emissions of road vehicles or the like.

The system 1 comprises an electronic appliance 2 installable on a vehicle V and suitable for collecting data relating to the use of the vehicle.

The system 1 also comprises a remote unit 3 suitable for determining the polluting emissions of the vehicle V during a predefined time or spatial interval, starting with the data collected by the electronic appliance 2.

With specific reference to the application of the invention within the field of environmental protection, it is pointed out that by “data relating to the use of the vehicle” is meant all those data potentially useful for the direct or indirect determination of the level of polluting emissions of the vehicle V.

As schematically shown in FIG. 2, the electronic appliance 2 comprises a locator unit for locating the position of the vehicle V, indicated by the reference 4.

The locator unit 4 can have a receiver 5 of the GNSS (Global Navigation Satellite System) type composed, e.g., of a GPS, Galileo, GLONASS receiver or the like.

In particular, the measurements taken by the locator unit 4 can comprise longitude, latitude and, if necessary, altitude coordinates of the vehicle V, along with other time and spatial references.

The electronic appliance 2 can also comprise a measuring device 6 for measuring the instantaneous acceleration of the vehicle V. Such measuring device 6 can be composed, e.g., of a two or three-axis accelerometer suitable for measuring the changes in acceleration of the vehicle V along two or three directions substantially not coplanar and at right angles to each other.

The electronic appliance 2 has a communication unit 7 suitable for sending the collected data to the remote unit 3. The communication unit 7 can comprise, e.g., a transmitter 8 and a receiver 9 operating within the spectrum of frequencies with mobile telephony protocols of the GSM, GPRS and UMTS type or the like.

Usefully, the electronic appliance 2 can comprise a processing and storage unit 10 connected to the locator unit 4, to the accelerometer 6 and to the communication unit 7.

In particular, the processing and storage unit 10 can have a microprocessor suitable for controlling the electronic appliance 2 and with temporary storage means for temporary storing the collected data, before sending by means of the communication unit 7.

Furthermore, the electronic appliance 2 can comprise an independent power supply unit.

The remote unit 3 is associated with at least one sub-system 11 of the type, e.g., of a GSM, GPRS, UMTS two-way radio/transmitter or the like, suitable for receiving and transmitting the data sent by the communication unit 7 of the electronic appliance 2.

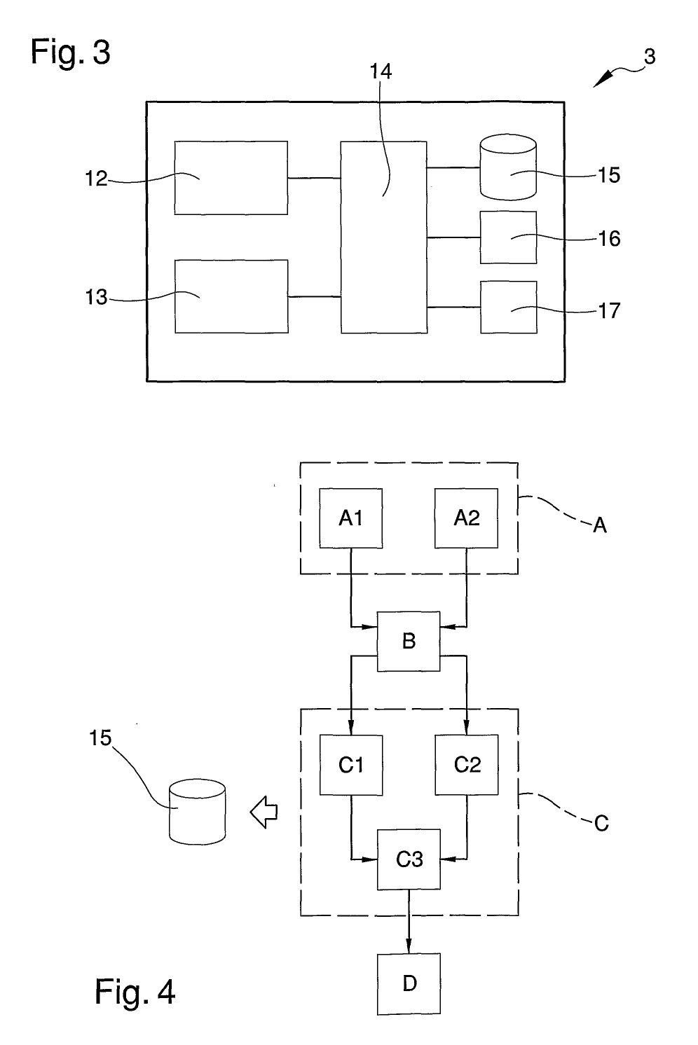

Advantageously, the remote unit 3 comprises first processing means, generically indicated in FIG. 3 by the reference 12, suitable for processing the position data of the vehicle V collected by the locator unit 4.

In particular, the first processing means 12 permit defining the distance covered by the vehicle V and/or the time the vehicle itself is actually used during a time interval of interest.

Advantageously, the remote unit 3 comprises second processing means, generically indicated in FIG. 3 by the reference 13, suitable for processing the instantaneous acceleration data collected by the measuring device 6.

In particular, the second processing means 13 permit defining the style of driving of the vehicle V during the above time interval.

It must be pointed out that by “style of driving” is meant all those data aimed at determining the speed of the vehicle V during transit; such data can comprise, e.g., the speed of the vehicle V and the intensity of the accelerations and of the decelerations of the vehicle itself.

The remote unit 3 further comprises calculation means, generically indicated in FIG. 2 by the reference 14, suitable for calculating the polluting emissions of the vehicle V during the time interval of interest.

In particular, such polluting emissions are calculated starting with the distance covered and the actual period of use determined by the first processing means 12 and starting with the style of driving determined by the second processing means 13.

Such calculation, e.g., can be made by comparing the collected data with the emission charts issued by the manufacturer of the vehicle V.

This permits an assessment of the polluting emissions that takes into consideration both the type of vehicle and the actual use of the vehicle itself.

Alternatively to the particular embodiment of the invention shown in the above figures, the electronic appliance 2 can be associable with a sensor suitable for detecting the instantaneous values of the polluting emissions of the vehicle V.

In this case, the data collected by the electronic appliance 2 do not comprise data useful for calculating the polluting emissions of the vehicle V, such as the distance covered by the vehicle or the style of driving, but comprise, on the other hand, data on the actual polluting emissions of the vehicle V detected directly by the sensor.

The calculation means 14, therefore, determine the polluting emissions of the vehicle V during the time interval of interest, starting with a plurality of instantaneous values of polluting emissions directly detected by the sensor.

Usefully, the remote unit 3 comprises a storage unit 15, of the type of a mass memory or the like, suitable for storing the data collected by the electronic appliance 2 and the data processed by the calculation means 14.

Advantageously, the remote unit 3 comprises comparison means 16 for comparing the polluting emissions calculated for the vehicle V with one or more reference values, for the definition of price rating and/or incentive plans directly related to the use of said vehicle.

Advantageously, the remote unit 3 can comprise determination means, indicated in FIG. 3 by the reference 17, suitable for determining the density of the polluting emissions inside a specific area.

In particular, the determination of the density of the polluting emissions is made starting with the data collected by a plurality of electronic appliances 2, installed on distinct vehicles V transiting inside the area.

Usefully, the first and the second processing means 12 and 13, the calculation means 14, the comparison means 16 and the determination means 17 can be realised by means of a dedicated software application.

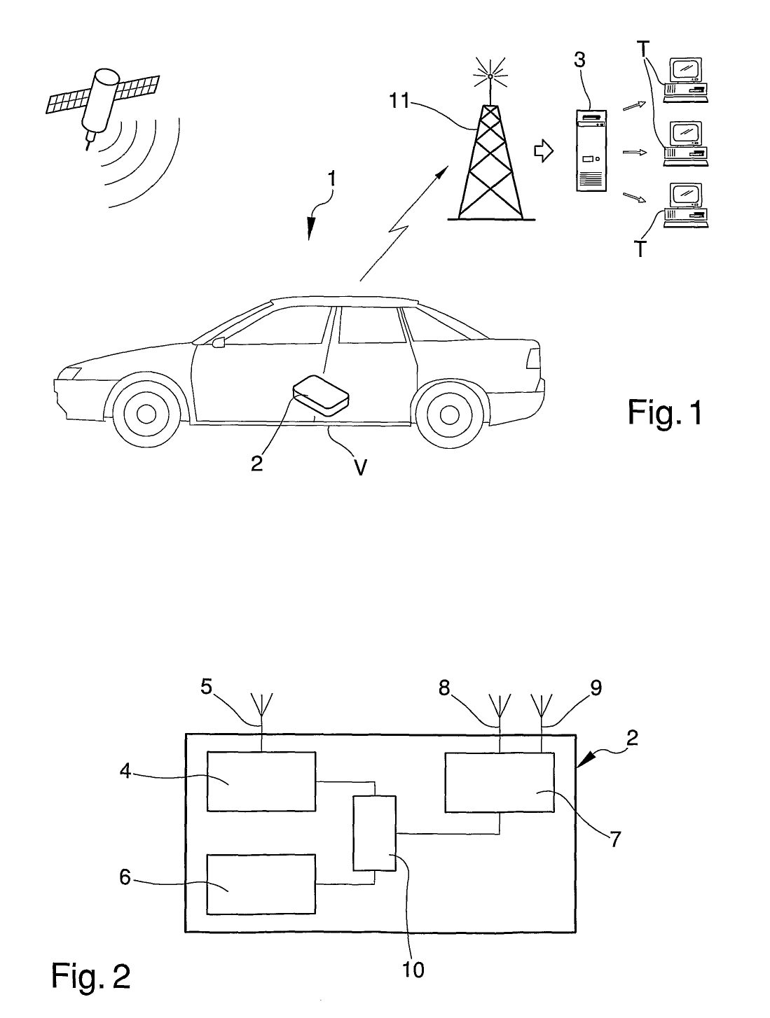

As shown in FIG. 1, the data relating to the polluting emissions of each vehicle V can be displayed by means of one or more terminals T associated with the remote unit 3.

The method according to the invention, schematically shown in FIG. 4, contemplates the collection of data relating to the use of the vehicle V by means of the electronic appliance 2 (phase A).

In particular, such collection phase can contemplate the location of the position of the vehicle V by means of the locator unit 4 (phase A1).

Furthermore, the collection phase (A) can contemplate the measurement of the instantaneous acceleration of the vehicle V by means of the accelerometer 6 (phase A2).

The data thus collected are then sent to the remote unit 3 by means of the communication unit 7 (phase B).

Subsequently, the remote unit 3 determines, starting with the collected data, the polluting emissions of the vehicle V emitted during at least one time or spatial interval of interest (phase C).

In particular, the determination of the polluting emissions can contemplate a first processing phase, by means of the first processing means 12, of a plurality of position data collected by the locator unit 4, suitable for defining the distance covered and/or the transit area and/or the period of use of the vehicle V during a time interval of interest (phase C1).

Usefully, the determination of the polluting emissions can contemplate a second processing phase, by means of the second processing means 13, of the acceleration data measured by the accelerometer 6, suitable for defining the style of driving of the vehicle V during the above time interval of interest (phase C2).

A calculation phase then follows, by means of the calculation means 14, of the polluting emissions of the vehicle V during the above time interval, starting with the distance covered, the period of use and/or the style of driving data of the vehicle itself (phase C3).

Alternatively, the collection phase (phase A) can comprise the detection of the instantaneous values of the polluting emissions by means of a sensor installed on the vehicle V and associated with the electronic appliance 2. In this case, the determination phase (phase C) contemplates the calculation of the polluting emissions of the vehicle V during a time or spatial interval of interest, starting with a plurality of instantaneous values detected by the sensor.

Usefully, the method can comprise the storage on the storage unit 15 of the data collected by the electronic appliance 2 and/or of the polluting emissions calculated by the remote unit 3.

Advantageously, the method comprises a subsequent phase of comparison of the polluting emissions calculated with several reference values, in order to define price rating and/or incentive plans that are directly related to the actual use of the vehicle V (phase D).

Usefully, the method can comprise the determination of the density of the polluting emissions within a predefined area, starting with the data collected by a plurality of distinct vehicles transiting within the area.

It has in fact been ascertained how the described invention achieves the proposed objects and in particular the fact is underlined that the system and the method described above permit evaluating the environmental impact of the vehicle in relation to the actual use of the vehicle itself.

This also allows determining price rating and/or incentive plans directly related to the actual polluting emissions of the vehicle.

Furthermore, the possibility of determining the density of the polluting emissions inside a specific area starting with the data detected by a plurality of transiting vehicles allows determining, with a fair degree of accuracy, the level of pollution produced by the vehicles alone.

This does in fact permit precisely measuring the polluting emissions of the vehicles, excluding from such measurement the polluting emissions produced by other sources (such as heating systems, etc.), normally read by traditional pollution measurement systems (sensors or the like).

The invention thus conceived is susceptible to numerous modifications and variations, all of which falling within the scope of the inventive concept.

Furthermore all the details can be replaced with others that are technically equivalent.

In practice, the materials used, as well as the contingent shapes and dimensions, may be any according to requirements without because of this moving outside the protection scope of the following claims.

1. A system for detecting the polluting emissions of road vehicles or the like, comprising at least one electronic appliance installable on a vehicle and suitable for collecting data relating to the use of the vehicle, and at least one remote unit suitable for determining the polluting emissions of said vehicle, during at least a predefined time or spatial interval and starting with said collected data.

2. The system according to claim 1, further comprising at least one communication unit associated with said electronic appliance and suitable for sending said collected data to said remote unit.

3. The system according to claim 1, wherein said electronic appliance comprises at least one locator unit for locating the position of said vehicle having a satellite signal receiver.

4. The system according to claim 3, wherein said remote unit comprises at least a first processing apparatus for processing the position data collected by said locator unit, for the definition of at least one between the distance covered, the period of use or the transit area of said vehicle during said time or spatial interval.

5. The system according to claim 1, wherein said electronic appliance comprises at least one measuring device for measuring the instantaneous acceleration of said vehicle.

6. The system according to claim 5, wherein said remote unit comprises at least a second processing apparatus for processing the instantaneous acceleration data collected by said measuring device, for the definition of the style of driving of said vehicle during said time or spatial interval.

7. The system according to claim 4, wherein said remote unit comprises at least a calculation apparatus for calculating the polluting emissions of said vehicle starting with at least one of the data chosen among said distance covered and said period of use.

8. The system according to claim 1, wherein said electronic appliance is associable with at least one sensor for detecting the instantaneous values of the polluting emissions of said vehicle.

9. The system according to claim 8, wherein said remote unit comprises at least a calculation apparatus for calculating the polluting emissions of said vehicle starting with said instantaneous values of the polluting emissions detected during said time or spatial interval.

10. The system according to claim 1, wherein said remote unit comprises at least one storage unit for storing the data collected by said electronic appliance and/or the polluting emissions calculated.

11. The system according to claim 1, further comprising at least a comparison apparatus for comparing the polluting emissions calculated with at least one reference value, for the definition of price rating and/or incentive plans directly related to the use of said vehicle.

12. The system according to claim 1, wherein said remote unit comprises at least a determination apparatus for determining the density of the polluting emissions inside a specific area, starting with the data collected by a plurality of electronic appliances installed on distinct vehicles transiting inside said area.

13. The system according to claim 3, wherein said satellite signal receiver is of the type used in GNSS satellite navigation systems, such as GPS, Galileo, GLONASS systems or the like.

14. The system according to claim 5, wherein said measuring device for measuring the instantaneous acceleration comprises at least one accelerometer.

15. The system according to claim 2, wherein said communication unit comprises at least a transmitter and/or a receiver operating within the spectrum of frequencies with mobile telephony protocols.

16. The system according to claim 15, wherein said mobile telephony protocols are selected from the group comprising GSM, GPRS and UMTS or the like.

17. The system according to claim 1, wherein said electronic appliance comprises at least one independent power supply unit.

18. A method for detecting the polluting emissions of road vehicles or the like, comprising collecting data relating to the use of at least one vehicle, and determining the polluting emissions of said vehicle, during at least a predefined time or spatial interval and starting with said collected data.

19. The method according to claim 18, further comprising sending said data collected by said vehicle to at least one remote unit.

20. The method according to claim 18, wherein said collection comprises the location of the position of said vehicle by means of a satellite signal receiver.

21. The method according to claim 20, wherein said determination comprises at least one first processing phase of a plurality of located positions, for defining at least one among the distance covered, the period of use or the transit area of said vehicle during said time or spatial interval.

22. The method according to claim 18, wherein said collection comprises measuring the instantaneous acceleration of said vehicle.

23. The method according to claim 22, wherein said determination comprises at least one second processing phase of the instantaneous acceleration data measured, for defining the style of driving of said vehicle during said time or spatial interval.

24. The method according to claim 21, wherein said determination comprises calculating the polluting emissions of said vehicle starting with at least one of the data chosen among said distance and said period of use.

25. The method according to claim 18, wherein said collection comprises detecting the instantaneous values of the polluting emissions of said vehicle.

26. The method according to claim 25, wherein said determination comprises calculating the polluting emissions of said vehicle, starting with said instantaneous values of the polluting emissions detected during said time or spatial interval.

27. The method according to claim 18, further comprising the storage of said data collected and/or of said polluting emissions calculated.

28. The method according to claim 18, further comprising the comparison of the polluting emissions calculated with at least one reference value, for the definition of price rating and/or incentive plans directly related to the use of said vehicle.

29. The method according to claim 18, further comprising the determination of the density of the polluting emissions inside a specific area, starting with the data collected by a plurality of distinct vehicles transiting inside said area.

30. The method according to claim 20, wherein said satellite signal receiver is of the type used in GNSS satellite navigation systems, such as GPS, Galileo, GLONASS systems or the like.

31. The method according to claim 19, wherein said sending the data collected to at least one remote unit comprises transmitting and/or receiving frequency modulated electromagnetic signals with mobile telephony protocols.

32. The method according to claim 31, wherein said mobile telephony protocols are selected from the group comprising GSM, GPRS and UMTS or the like.

33. The system according to claim 6, wherein said remote unit comprises at least a calculation apparatus for calculating the polluting emissions of said vehicle starting with said style of driving.

34. The method according to claim 23, wherein said determination comprises calculating the polluting emissions of said vehicle starting with said style of driving.
